(19) United States
(12) Patent Application Publication
(10) Pub. No.: US 2002/0080093 A1
(43) Pub. Date: Jun. 27, 2002

(54) Communication network for outdoor signs

(76) Inventor: Clarence Harold Bandura, Los Angeles, CA (US)

Correspondence Address: Clarence H. Bandura, P. O. Box 811651, Los Angeles, CA, 90081, US

(21) Appl. No.: 09/747,840

(22) Filed: Dec. 21, 2000

(51) Int. Cl. G09G 5/00

(52) U.S. Cl. 345/6

(57) ABSTRACT

Electronic communication communication via the internet and computer allows for exchange of information for the purposes of electronic display and can also include added electronic transmissions from satellite, radio television, virtual blanking, telephone, and cable. The internet provides a means to exchange data and control the ultimate destination of the displayed information being singular or multiple locations with no restrictions of distance and display time.

### CROSS-REFERENCE TO RELATED APPLICATIONS

No references relate to this one

### BACKGROUND OF THE INVENTION

Communication networking for outdoor signs was a limited application. With the advent of the internet among other electronic communications it is now possible to network data and display information.

### DETAILED DESCRIPTION OF THE PREFERRED EMBODIMENT

Outdoor signs are networked with this invention via: the internet, television broadcast signal, (either normal television reception) or virtual blanking intervals, radio frequency, satelite transmission and other electronic signals thereby enabling the exchange and transmission of data for display purposes.

Data can be inputed from a computer through one or all of these electronic communication systems.

Communication can be one or two way for the purposes of message display on outdoor signs. (i.e. Billboards, parking lot signs, sidewalk signs, bus shelters, and other outdoor signage. Communication may originate or utilize data from indoor displays in order to obtain requested information.

I claim:

1) Electronic communication and networking of data for display on outdoor signs.

2) communication and data exchange as claimed in claim 1 via the internet and computers.
satelite, television broadcasting, virtual blanking intervals, and radio frequency provide additional data via wireless and telephone or cable via hard-wired

3) communication and data exchange as claimed in claim 1 for timed intervals of display.

4) networking of data as claimed in claim 1 further including designated areas or zones.

5) display of data in claim 1 is electronic display of text or graphics.
